(19) United States
(12) Patent Application Publication
(10) Pub. No.: US 2002/0174192 A1
(43) Pub. Date: Nov. 21, 2002

(54) Multi-media e-data transfer system and method

(76) Inventor: Bruce A. McKenzie, Sanford, FL (US)

Correspondence Address: Terry M. Sanks, Esquire, Beusse, Brownlee, Bowdoin & Wolter, P.A., Suite 2500, 390 North Orange Avenue, Orlando, FL, 32801, US

(21) Appl. No.: 10/151,550

(22) Filed: May 17, 2002

Related U.S. Application Data
(60) Provisional application No. 60/291,697, filed on May 17, 2001.

(51) Int. Cl. G06F 15/16

(52) U.S. Cl. 709/217

(57) ABSTRACT

A method for accessing, retrieving, and transferring data electronically in a publicly accessible location, the method comprising providing a user interface device at a location accessible by a general populace where the user interface device comprises at least one of an image scanning input device for downloading an image, a film scanning input device for processing and downloading film negatives, a media transfer device, a wireless data transfer device, an audio/video transfer device, an audio recording input device, an image recording input device, and a user control device; providing a data storage device where data sent and received is stored; providing a network which connects the user interface device with the data storage device; allowing a user to enter data into the user interface device for later retrieval; allowing a user to retrieve data using the user interface device; and paying for at least one of the allowing a user to enter data and the allowing a user to retrieve data.

This application claims priority of Provisional Patent Application Serial No. 60/291,697, filed on May 17, 2001.

### BACKGROUND OF THE INVENTION

This invention relates to a data transfer system, and more particularly to a system for transferring various types of data from one location to another location where the data is accessible for storage in either a producible physical form or a remote data storage device.

Technology has advanced to where consumers use information, which can be communicated electronically for many daily activities, both for professional and pleasurable use. For example, portable hand-held devices are now used which allow consumers to download email and electronic calendars from a primary computer system and then keep this information with them while away from the primary computer system. Typically when the consumer wishes to update a calendar or retrieve new email, the consumer must access a computer integrated with the primary computer system where the master email account or calendar resides. Thus if the consumer is away from such a computer, the consumer is unable to complete the desired update. This update is typically done at a consumer's home computer or on the consumer's primary work computer.

Similarly, with the advances in computer technology and computer networks, such as the Internet, consumers with business or home computers can transmit and receive photographs, digital video, or streaming video. However, the recipients must also possess the same, or similar, type of technology to receive and view the data transmitted. With respect to music and software, there are several prior art vending machines that allowing consumers to select information of choice, even prior art that uses a remote storage facility to store data before a consumer seeks to download the data.

However, with the increased use of portable devices for both professional and pleasurable needs, consumers would benefit from a system that would allow them to complete a variety of electronic transfers from a single remote interface system. This system would be accessible from locations other than a computer system that a consumer typically has access to, such as a home computer or a business computer.

### BRIEF DESCRIPTION OF THE INVENTION

Towards this end, a system for uploading, transferring and downloading information between a public accessible first location and a public accessible second location is disclosed. The system comprises a user interface device at the first location and the second location. The user interface device comprises at least one of an image scanning input device for loading an image, a film scanning input device for processing and loading film negatives, a media transfer device, a wireless data transfer device, an audio/video transfer device, an audio recording input device, an image recording input device, a user control device for determining which of at least one of the image scanning input device, the media transfer device, the wireless transfer device, the audio/video transfer device the voice recording input device and the image recording device to use, and a payment-processing device.

A data storage device at a third location for storing transferred information is also provided in the system, as well as an electronic network connecting the devices and the data storage device. A user can complete at least one of a download and a retrieval of information through the user interface device at the first location where the information is saved at the data storage device at the third location, and the information is retrieved from at least one of the user interface devices at the first location and the user interface device at the second location.

A method for accessing, retrieving, and transferring data electronically in a publicly accessible location is also disclosed. The method comprises for providing a user interface device at a location accessible by a general populace where the user interface device comprises at least one of an image scanning input device for downloading an image, a film scanning input device for processing and downloading film negatives, a media transfer device, a wireless data transfer device, an audio/video transfer device, an audio recording input device, an image recording input device, and a user control device. The method also provides a data storage device where data sent and received is stored, and a network that connects the user interface device with the data storage device. The method allows a user to enter data into the user interface device for later retrieval. The method also allows a user to retrieve data using the user interface device. The user also pays for at least one of allowing a user to enter data and allowing a user to retrieve data.

### BRIEF DESCRIPTION OF THE DRAWINGS

The features and advantages of the present invention will become apparent from the following detailed description of the invention when read with the accompanying drawings in which:

FIG. 1 is an exemplary illustration of a unit where a user may receive and/or initiate transfer of data;

FIG. 2 is an exemplary block diagram embodiment of an inter-connection network of the present invention; and

FIG. 3 is an exemplary block diagram of the present invention in operation.

### DETAILED DESCRIPTION OF THE INVENTION

With reference to the figures, exemplary embodiments of the invention will now be described. The scope of the invention disclosed is applicable to a system for allowing a user to access and store various forms of electronic data for later use on another device separate from the system disclosed. Thus, even though this invention is disclosed specific to the transfer of only several transferable electronic data, this invention is applicable to all forms of electronic data in general.

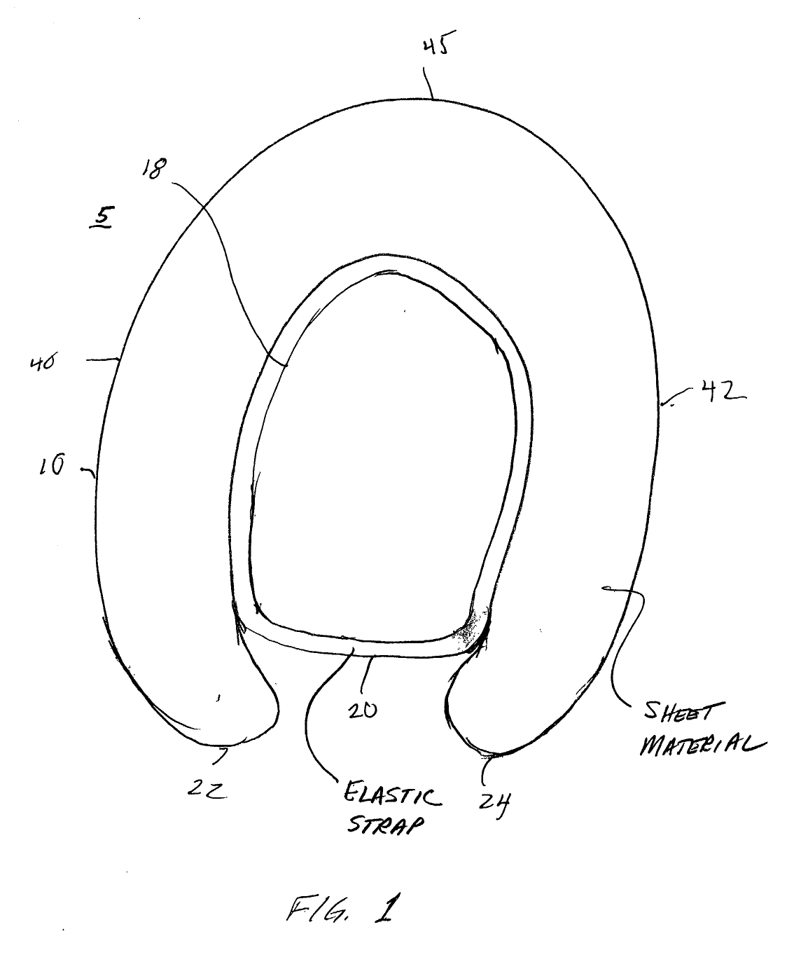

FIG. 1 is an exemplary illustration of a unit where a user may receive and/or initiate transfer of data. The unit, or user interface device 5 has a user control device 10. In a preferred embodiment, the user control device 10 is a monitor, and is a primary interface device for a user to engage the system. The monitor is a touch screen monitor and all functions are provided to a user through a menu driven program accessible by accessing the touch screen of the monitor. In another preferred embodiment, the user control device 10 is a keyboard and monitor. In another preferred embodiment, the user control device is a monitor and button combination where a user is directed to select specific buttons.

The user interface device 5 also has an image scanning input device 12. This device is a scanner that will allow a user to load an image of a document or photograph into the system. In a preferred embodiment, once scanned, a user can allow the scanned document to be stored for later retrieval by the user or another user at either the same location or a second location. If the scanned document contains text, the user can have the user interface device convert the scanned image to editable text before storing the document for later retrieval. The user interface device 5 also has a facsimile capability (not shown) where the scanned document could be sent as a facsimile to any facsimile machine, either immediately or at a later predetermined time. In another preferred embodiment, the document may be emailed.

The user interface device 5 has a film scanning input device 14, such as a sequential film scanner. The film-scanning device 14 is able to process film negatives. Once processed, using the user control device 10, the user will have the same options discussed previously to apply with the processed film.

The user interface device 5 also has a media transfer device 16. In a preferred embodiment the media transfer device 16 may be a plurality of devices capable of loading data on a plurality of media devices. In another preferred embodiment a multi-functional media transfer device 16, 17 is available that is able to accommodate a plurality of media devices. As an illustration, the various forms of media transfer devices comprise, but are not limited to CD-ROM, DVD, memory module reader/card, unique game storage devices, and any form of data storage or transfer devices. In a preferred embodiment, when desiring to transfer data to a media device, the user will be prompted to select the desired device. A file selection menu will then be presented to allow the user to select specific files, such as commercially available data files, to be transferred to the media device. Commercially available data files include, but are not limited to music selections, gaming software, computer software, electronic training, etc. In a preferred embodiment, the user interface device 5 has a supply of various media devices, so that when a user makes a selection, the user interface device 5 provides the media device for storing information selected. In another preferred embodiment, a user will supply the media device to the user interface device 5. The user interface device 5 does not limit the types of data that can be transferred. The user interface device 5 also has a printer device (not shown) to print information directly on the media device. In another preferred embodiment, the printer device also has a label dispenser where information is printed on the label and then applied to the media device.

Another form of transfer device available is a wireless transfer device 18. The wireless transfer device 18 will be able to transfer data using any form of wireless transfer technology, or protocol, such as but not limited to infrared and Bluetooth. With respect to these two types of transfer technologies, for infrared, the user is prompted to point the receiving media device (not shown) at the infrared transceiver located on the user interface device, and for Bluetooth, the transceiver may be internal to the user interface device. The receiving media device 18 may be a Palm Pilot™ or other hand-held electronic device.

The user interface device has an audio/video transfer input device 20, 21. A user uses this device to connect an external device, image or audio gather device, such as a camcorder or digital camera to the available audio/video connectors and then initiate a transfer for stored images on the external device. Thus, an image in either a still or motion format may be transferred.

The user interface device also has an audio recording input device 24, or microphone. In operation, the user is directed to activate the audio recording input device 24, such as by pushing a button, to begin an active recording session and to end the active recording session. Similarly, the user interface device 5 has an image recording input device 25, or video camera. As with the audio recording input device 24, in operation, the user is directed to activate the image recording input device 25, such as by pushing a button, to being an active recording session and to end the active recording session. The user can use the audio recording input device 24 and the image recording input device 25 together to record a streaming video, or motion picture where both an image and sound are both desired. The user can transfer the resulting photo, sound, or-streaming video as discussed previously.

A speaker system 27 is also part of the user interface device. The speaker system may be used to provide auditable directions to the user. In another preferred embodiment, if the user is using the user interface device to purchase music, the user can preview the music selected via the speaker system. The speaker system 27 may be either speakers where individuals passing by may also hear the audio being played or headsets so that only the user can hear the audio. The user interface device 5 further has a media dispenser 30. Once media is transferred to a media device, it is then dispensed to the user by way of the media dispenser.

In a preferred embodiment, the user interface device 5 has more than one media transfer devices. A first media transfer device 16 is in a location where it is accessible by the user. A second media transfer device (not pictured) is internal to the user interface device 5. When the user uses a media device supplied by the user interface device 5, the media device is then dispensed to the user by way of media dispenser 30. Before dispensing the media device, in a preferred embodiment the media device is packaged in a media container, and information about the data on/in the media device is printed on the media device. In a preferred embodiment, the media dispenser 30 is padded with a soft material, such as rubber or foam, to reduce damage to the media device being dispensed.

The user interface device 5 has a payment-processing device 32. In a preferred embodiment, the payment-processing device is capable of accepting either a credit/debit card as well as hard currency. In another preferred embodiment, a user may access a bank account and have the required funds transferred directly to the user interface device 5 or a financial agency responsible for the user interface device's financial transactions. The payment-processing device 32 also has a receipt printer 33. Thus the user has several payment options. As previously mentioned, the user can pay for the use of the system with a credit/debit card, cash payment, or an electronic funds transfer. Additionally, other payment options are, but not limited to, an electronic wallet payment system, a gift certificate, and/or a pre-established personal/corporate account associated with the user interface device. The user interface device 5 also has a commercial grade telephone device 35. The telephone is available for a plurality of functions, including but not limited to, voice commands, voice identification, Internet phone calls, Customer Service, etc.

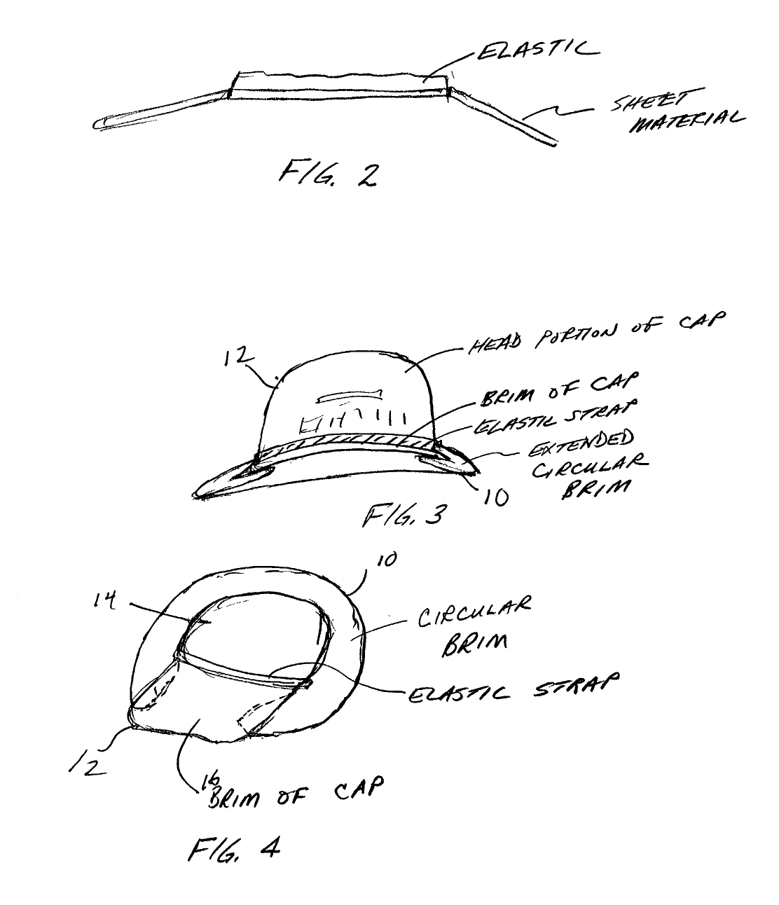

FIG. 2 is a block diagram embodiment of an inter-connection network of the present invention. FIG. 2 illustrates a plurality of user interface devices 5 in two general locations, specifically City “A” 40 and City “B” 42, where each user interface device is remote of the other user interface devices 5 in each respective general location. A server, or a remote data storage facility 45 is located at a third location. In a preferred embodiment, a backup carrier 47 is provided from the server 45 to the user interface device 5 in case a primary carrier fails. The system 50 transfers data over a computer network 52. In a preferred embodiment the network 52 is a private network. In another embodiment, the network 52 is a publicly accessible network, such as the Internet. In another preferred embodiment, the Internet is used in combination with a Virtual Private Network (VPN). In all embodiments, the connectivity can be either wired or wireless.

The server 45 also has connectivity to a public computer network 55, such as the Internet. With this connection, a user can order commercially available data, such as music selections and/or a software game from a home or business computer 61 by entering a web site specific to the system 50 or by emailing a request to the system 50. The user can specify where the selected data will be received, such as by identifying a specific user interface device. In another preferred embodiment, the user can be provided a code and password to access the ordered data from any user interface device.

The server 45 will also monitor the user interface device 5 to determine whether the user interface device 5 is functioning properly. In a preferred embodiment, the servers will also monitor the user interface device to determine whether supplies at the user interface device 5 are running low. Such supplies may include, but are not limited to blank media devices, labels, and printer ink.

As further illustrated, the user can either transfer data directly to the server 45 for later retrieval at either an user interface device 5 in either City “A” 40 or City “B” 42 or the user can send the data directly to another user interface device 5 in a second location, such as from City “A” 40 to City “B” 42. In a preferred embodiment, if several user interface devices are in a close geographic area 60, such as an amusement park, the data is sent to all user interface devices 5 in that close geographic area 60.

In operation, the user has several options. If the user simply needs to retrieve data that the user knows is available, such as calendar updates, or to download music or an electronic game, the user will use the touch screen or monitor on the user interface device to go though the menu driven software to obtain the data sought. This data is stored either at a remote storage facility or may reside on a hard drive at the user interface device being used by the user. In a preferred embodiment, and with respect to downloading music, the menu driven software will allow a user to create personal CD's or DVD's where specific songs are downloaded as oppose to a complete composition of songs typically found on a single CD. Similarly, the user may download data, such as a scanned image or downloaded film where the user can either retrieve this data in an electronic format or send this data to the remote storage facility or to a user interface device at another location.

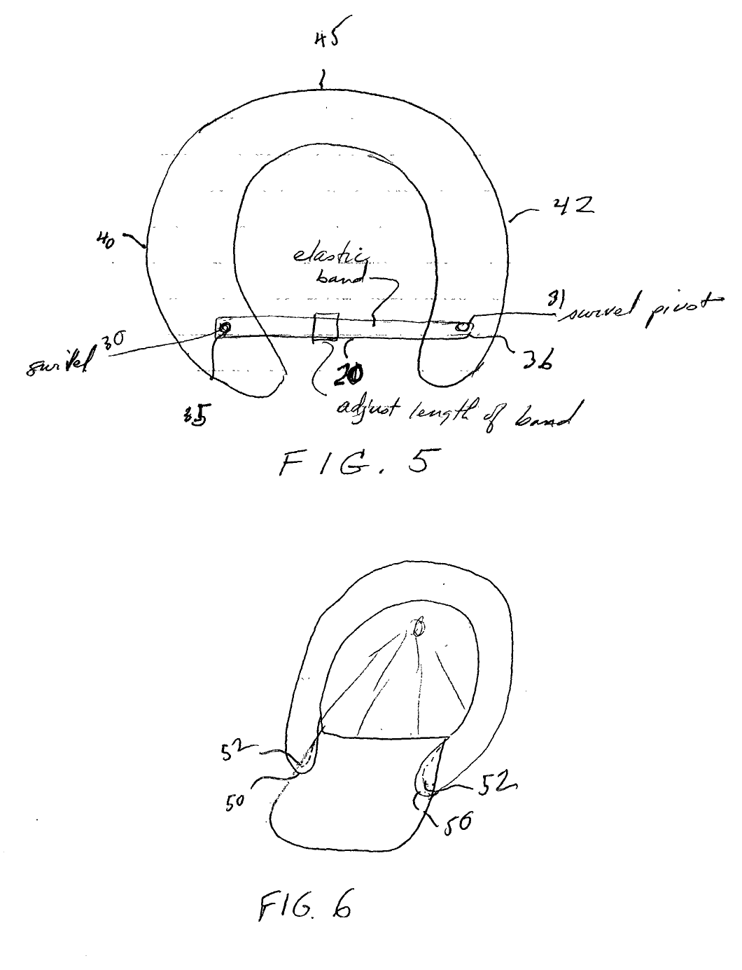

More specifically, as illustrated in FIG. 3, a user interface device is provided in a location accessible to a general populace Step 65. A data storage device is also provided, Step 67, where a network connects the user interface device and data storage device Step 69. The user may enter data into the user interface device for later retrieval, Step 71. Such data may include, but is not limited to, electronic calendar data, images, documents, and audio/video files, such as camcorder recordings. The user may retrieve data using the user interface device Step 73. The data may include, but is not limited to, data previously entered by any user, and commercially available data, such as, but not limited to, music selections and computer software. The user will have to use a payment option to pay for using the user interface device Step 75.

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

We claim as our invention:

1. A system for uploading, transferring and downloading information between a public accessible first location and a public accessible second location, said system comprising:
a) user interface device at said first location and said second location wherein said devices comprises at least one of:
1) an image scanning input device for loading an image;
2) a film scanning input device for processing and loading film negatives;
3) a media transfer device;
4) a wireless data transfer device;
5) an audio/video transfer device;
6) an audio recording input device;
7) an image recording input device; and
8) a user control device for determining which of at least one of said image scanning input device, said media transfer device, said wireless data transfer device, said audio/video transfer device said voice recording input device and said image recording device to use.
b) a payment-processing device;
c) a data storage device at a third location for storing transferred information;
d) an electronic network connecting said devices and said data storage device; and
e) wherein a user can complete at least one of a download and a retrieval of information through said user interface device at said first location where said information is saved at said data storage device at said third location, and said information is retrieved from at least one of said user interface devices at said first location and said user interface device at said second location.

2. The system of claim 1 wherein said image scanning input device further comprises a facsimile device to transfer a scanned document by facsimile transmission.

3. The system of claim 1 wherein said wireless transfer device allows for transferring data between a remote hand held device and said user interface device using a wireless media protocol.

4. The system of claim 1 wherein said image recording input device processes film negatives.

5. The system of claim 1 wherein said audio/video transfer allows a transfer of an image to and from an image-gathering device.

6. The system of claim 1 wherein said audio/video transfer allows a transfer of sound to and from an audio-gathering device.

7. The system of claim 1 wherein said voice recording input device creates a voice recording that is stored for later retrieval.

8. The system of claim 1 wherein said user control device is operable to allow said user to select a commercial available data file for retrieval.

9. The system of claim 1 wherein said user interface device further comprises a printer device.

10. A method for accessing, retrieving, and transferring data electronically in a publicly accessible location, said method comprising:
a) providing a user interface device at a location accessible by a general populace where said user interface device comprises at least one of an image scanning input device for downloading an image, a film scanning input device for processing and downloading film negatives, a media transfer device, a wireless data transfer device, an audio/video transfer device, an audio recording input device, an image recording input device, and a user control device;
b) providing a data storage device where data sent and received is stored;
c) providing a network which connects said user interface device with said data storage device;
d) allowing a user to enter data into said user interface device for later retrieval;
e) allowing a user to retrieve data using said user interface device; and
f) paying for at least one of said allowing a user to enter data and said allowing a user to retrieve data.

11. The method of claim 10 wherein said step of allowing a user to enter data into said user interface device for later retrieval further comprises scanning a document to create an electronic version of said document.

12. The method of claim 10 wherein said step of allowing a user to enter data into said user interface device for later retrieval further comprises scanning a film negative to create an electronic version of an image on said film negative.

13. The method of claim 10 wherein said step of allowing a user to retrieve data using said user interface device further comprises allowing a user to select commercially available data and loading said data to a media transfer device.

14. The method of claim 10 wherein said step of allowing a user to retrieve data using said user interface device further comprises transferring data between said user input device and a remote hand held device.

15. The method of claim 14 wherein transferring data further comprises transferring said data using a wireless data transfer device.

16. The method of claim 10 wherein said step of allowing a user to enter data into said user interface device for later retrieval further comprises transferring an image using said image gathering device.

17. The method of claim 10 wherein said step of allowing a user to enter data into said user interface device for later retrieval further comprises transferring an audio sound using said audio gathering device.

18. The method of claim 10 wherein said step of allowing a user to enter data into said user interface device for later retrieval further comprises creating a sound recording with said voice recording input device.
